(19) United States
(12) Patent Application Publication
(10) Pub. No.: US 2018/0287817 A1
(43) Pub. Date: Oct. 4, 2018

(54) Method of control of a packet-based data communications system and communications system implementing the method

(71) Applicant: SATCOM1 APS, Greve (DK)

(72) Inventors: Jean-François GAULT, Margency (FR); François GOUDAL, Margency (FR)

(73) Assignee: HONEYWELL INTERNATIONAL INC., Morris Plains, NJ (US)

(21) Appl. No.: 15/765,959

(22) PCT Filed: Oct. 3, 2016
(86) PCT No.: PCT/EP2016/073557

§ 371 Date: Apr. 4, 2018

(30) Foreign Application Priority Data
Oct. 5, 2015 (FR) 1559435

(51) Int. Cl. H04L 12/46

(52) U.S. Cl. CPC H04L 12/4633; H04W 84/06; H04L 2212/00

(57) ABSTRACT

The embodiments described herein provide methods and device for encapsulating a packet in an envelope appertaining to the determined channel and/or to the determined link and in transmitting the envelope with the packet destined for a server which executes an extraction of the data packet from its envelope and forwards it finally on a link to the destination communication part. These embodiments finds application in communication system incorporating routers, and especially routers installed on systems embedded aboard vehicles of all sorts but also on objects incorporating a communication part for an inter-object data communications system.

### PRIORITY CLAIM

This application is a U.S. National-Stage entry under 35 U.S.C. § 371 based on International Application No. PCT/EP2016/073557, filed Oct. 3, 2016, which claims priority to French Application No. 1559435, filed Oct. 5, 2015, both of which are incorporated by reference herein.

### TECHNICAL FIELD

The present invention relates to a method of control of a packet-based data communications system. It also relates to a communications system implementing such a method. It finds application especially in communication systems incorporating routers, and especially routers installed on systems embedded aboard vehicles of all sorts but also on objects incorporating a communication part for an inter-object data communications system.

### BACKGROUND

Hereinafter in the text, and also in the foregoing, the term “communication part” refers to a part of the communication system which exchanges data packets with at least one other communication part. Such is the case in respect of a client, or else of a server, or of an entity combining a client and a server, on the Internet network. A “communication part” can be a sender of a communication packet or a recipient of the packet depending on whether the data packet exits or enters the electronic device which implements the “communication part” in the communications system.

It is in particular known that each communication part is associated with an address in the network and also that each data packet comprises auxiliary data of the data which represent the message fraction generated by the sending communication part. Included among these auxiliary data, also called metadata, are the address of the sender communication part, the address of the recipient communication part, the size of the packet and/or of the message, the lifetime of the packet in the communication system and yet other data. These metadata are usually defined by the standards documents of the communication protocols.

Each communication part is linked to the communication system by at least one link by means of an electronic system composed essentially of a modem capable of modulating, respectively demodulating, the digital data of the data packet according to the communication protocol chosen on the link. Such a link can be effected on an optical fibre, an RF beam, a satellite communications beam, or the like.

Moreover, between a sender communication part and a recipient communication part, there may be successively several heterogeneous links such as a satellite link between an aeroplane and the ground, and then an optical fibre link on the terrestrial network so as to get to a server such as a recipient communications part.

Finally, a sender communication part is generally also a recipient communication part. Such is the case in particular on the Internet network in respect of a client which is firstly a sender communication part sending a request, for example of http type. The http request transmitted in the form of data packets is then received by a server, the recipient communication part, which interprets the request and produces a response such as an html page or other item of data, which is in its turn sliced up into data packets. The server then becomes the sender communication part and the client the recipient communication part so as to receive the html page which is then displayed on a browser of the client.

In the prior art, it is known that links between communications parts can exchange data packets. Each packet consists of a set of binary data representing a part of a communication message and of a set of communication metadata such as identifiers of the sending part and of the recipient part, the size of the packet, the lifetime in the communications system and much other service information. An example of the architecture of such data packets is described in the standardization documents of various communication protocols which are relevant to the present invention and in particular the IP (RFC 791), TCP (RFC 793) or else UDP (RFC 768) protocols. The reference RFC relates to one or more documents published by the IETF standardization body, and to which one may refer. Of course, other communication protocols are also relevant to the invention, some of which will be mentioned further on, and they are also relevant to the invention.

When a data packet has been prepared by a communications part of the communications system, it must be injected into a communication channel determined from among a plurality of communications channels prepared on a remote link with another communication part. Such a channel makes it possible to transmit determined packets having in particular a determined size and determined bitrate of data. The link then transmits them to the recipient part or parts.

On a recipient part, the reverse mechanism is used in which the channel is identified and its data packets are extracted and associated as a data stream utilizable by the recipient part.

The mechanism has been succinctly represented from the sender communication part in FIG. 1. In FIG. 1, the communications part comprises a communication data stream producer device 1. The data stream is sliced up into data packets by a device for formatting data packets 2. Each data packet is then stored in a buffer 3 for sending data packets. It is then necessary to execute the transit of the data packet on the link 6. Such a link makes it possible to broadcast several channels so that the sending of a data packet must firstly give rise to the assigning of the data packet arising from the formatter 2. The buffer 3 is then read with the aid of a device for selecting channels 4 which inserts each data packet extracted from the buffer 3 on a determined channel and is then provided as input to a modem 5 which actuates the dispatching of the data packets in the channels decided on the link 6 of the communications system.

In the prior art, it is also known that a communications part in the communications system amalgamates the calculation or processing resources necessary for transforming a data stream into one or more channels on a so-called router device which also executes routing operations. All these routing operations will not be recalled here because they relate to other communication aspects and are well known to the person skilled in the art.

Routing essentially being a processing of communication data, it is understood that it can be implemented in one or more distinct devices. In the limit, the router can be effected entirely in a software manner on the item of equipment which produces the data stream 1. But, returning to the architecture described in FIG. 1, it can also be independent thereof and implement the whole set of functions described, including as far as the modem or just in part.

In FIG. 2 is described a communication part in which several users, User#1, . . . User#n can be connected to one out of several links 13, 13b, 13c. For this purpose, the communication part, for its “sender” part, comprises a data packetizing device 10. Each data packet is thereafter assigned as has been described hereinabove, by a channel selector 11 in a channel of a determined link 13a, 13b or 13c. A switch S driven by a drive signal SC produced by a device for control of the communication part, selects one of the links with its modem 12a, 12b or 12c through which the data are then transmitted.

Of course, reception is executed in a symmetric manner by electronic means reciprocal to those of the sender on the recipient communication part, which is not represented.

In the prior art, it is also known that the router can access more than one link. Such is the case in particular in respect of routers embedded aboard an aircraft and which comprise several links, including a high-bitrate bidirectional satellite link, a low-bitrate bidirectional satellite link, and sometimes a unidirectional satellite TV link. Other temporary links for example such as a mobile telephone link of GSM or UMTS standard are also known.

In particular, a link may be interrupted when the aircraft in which the router is installed exits a zone of coverage of the initially activated link. This interruption is particularly known within the framework of satellite communications, the satellite often being geostationary and covering only a necessarily limited geographical zone. It is then known to negotiate a closure of communication session on the link currently undergoing interruption and to open a new communications session on another link that has become available.

In the prior art, it is also known that the transport of a data packet on a determined link exhibits a determined cost and a determined quality. Thus, the bitrate, the size of the packets, their lifetime in the communications system, the packet transmission failure rate, depend in particular on the link chosen. A need therefore exists for it to be possible to redirect the packets in a more flexible manner on the suitable channel and/or on the appropriate available link according to a plurality of transmission cost and transmission quality criteria.

The technique which consists in injecting data packets into a channel on an available link and in receiving them in a reciprocal manner is known. But it is limited in particular by the fact that the communications protocols prevent the communication from being interrupted. Now, such an interruption may occur in numerous circumstances and particularly when one of the communication parts is disconnected from the link on which it is exchanging data packets. Such is the case when the link is a satellite link and when the communication part exits the zone of coverage of the satellite with which the link is established.

Moreover, the communications protocols require that, when the data packet has been transmitted, service data, such as those of a mechanism for acknowledgment or for determining the available bitrate be effected on the same channel and the same link. It follows from this that no mechanism exists which allows flexible management of the insertion of a packet into a channel on a determined link.

### BRIEF SUMMARY

The embodiments described herein provide a remedy to the drawbacks of this prior art. Indeed, it relates to a method of control of a packet-based data communications system of the kind in which each data packet can be injected into a determined channel on a determined link. According to the embodiments described herein, the methods and devices can include the encapsulating of a packet in an envelope appertaining to the determined channel and/or to the determined link and in transmitting the envelope with the packet destined for a server which executes an extraction of the data packet from its envelope and forwards it finally on another link to the destination communication part.

### BRIEF DESCRIPTION OF THE DRAWINGS

Other characteristics and advantages of the present invention will be better understood with the aid of the description and of the appended drawings, among which:

FIG. 1 represents a first prior art

FIG. 2 represents a second prior art;

FIG. 3 represents a concept used in the method of the invention;

FIG. 4 represents the sending part of a communication system implementing an embodiment of the invention;

FIG. 5 represents the recipient part of the communication system of FIG. 4;

FIG. 6 represents a mechanism implemented in another embodiment of the invention;

FIG. 7 represents a mechanism implemented in another embodiment of the invention; and

FIG. 8 represents an embodiment of the invention in an avionics application.

### DETAILED DESCRIPTION

The embodiments described herein provide method and devices of control of a packet-based data communications system of the kind in which each data packet can be injected into a determined channel on a determined link. According to these embodiments, the method includes encapsulating the packet in an envelope appertaining to the determined channel and/or to the determined link and in transmitting the envelope with the packet destined for a server which executes an extraction of the data packet from its envelope and forwards it finally on another link to the destination communication part.

According to additional characteristics, the method:
at the level of the relay-server, consists in modifying service metadata of each data packet in such a way that the destination communication part addresses its response in the form of data packets addressed to the relay-server;
at the level of the relay-server, consists in aggregating the data packets received from the recipient communication part in envelopes containing service metadata so as to transmit them to the sender communication part on a determined channel and/or a determined link;
consists in transmitting the envelopes of data packets on distinct channels of distinct links;
one of the links being unidirectional, it consists in constructing a return pathway of the unidirectional link by injecting the envelopes and/or the data packets on channels of a link available in the other direction of transmission;
consists in detecting a cutoff of a link so as to select the channels of another available link in such a way as not to interrupt the communication;
consists in selecting a link as a function of predetermined constraints which include: the bitrate available on a link; the latency time on a link; the cost of forwarding on a link; and any other criterion making it possible to select one or other link from among the links available on the communications part;
consists in executing a predetermined algorithm for allotting the data packets to be encapsulated in envelopes determined as a function of constraints predetermined on the basis of characteristics of the data packets and/or of the envelopes, and in particular as a function of the size of the data packets;
the allotment of the packets is executed on the basis of static information related to the supervision of the channels comprising: the bitrate or the bandwidth, the latency, the jitter, the transmission cost or a combination of these characteristics;
the allotment is executed in a random manner or by taking account of the degree of fill of a channel on a given link, and/or of the transmission cost;
the allotment is executed by filtering the packets according to desired transmission characteristics and by detecting these transmission characteristics on the channel/link pairs available, in particular as a function of the transmission cost, or by filtering the urgent packets on the low-latency channel/link pairs.

It also relates to a communications system implementing such a method. The communication system of the invention is of the kind in which several communication parts exchange data packets on at least one link. According to the invention at least one communication part comprises a device for aggregating at least one data packet in an envelope of data packets which also comprises service metadata, a device for inserting the said envelope into a channel selected from among a plurality of channels open on a link selected from among the available links, in that it comprises at least one relay-server selected according to the service metadata of the envelope which exchanges envelopes of data packets with the said at least one communication part, the relay-server comprising a device for extracting the data packets from the envelopes received from the said at least one communication part, and for transmitting them to at least one recipient communication part.

According to additional characteristics:
the relay-server also comprises a device for encapsulating the data packets transmitted by a communication part to the relay-server in an envelope so as to transmit them to the recipient communication part on a determined channel and/or a determined link.
at least one communication part comprises a communication part controller for executing the selection of a channel and of a link as a function of predetermined constraints.
the communication part controller and the devices for encapsulating and de-encapsulating the data packets in envelopes, the devices for selecting channel and/or link are implemented on a data packet router.
the system comprises at least one nominal satellite link.
among the available links are: a unidirectional link such as a link to a television broadcasting satellite; and a low-bitrate link to a communication satellite.

The invention also relates to the use of the communication system aboard an aeronautical, aerospace, maritime, terrestrial vehicle or on at least one connected object, the vehicle being able to be automatic.

The invention also relates to the use of the communication system installed on a fixed device.

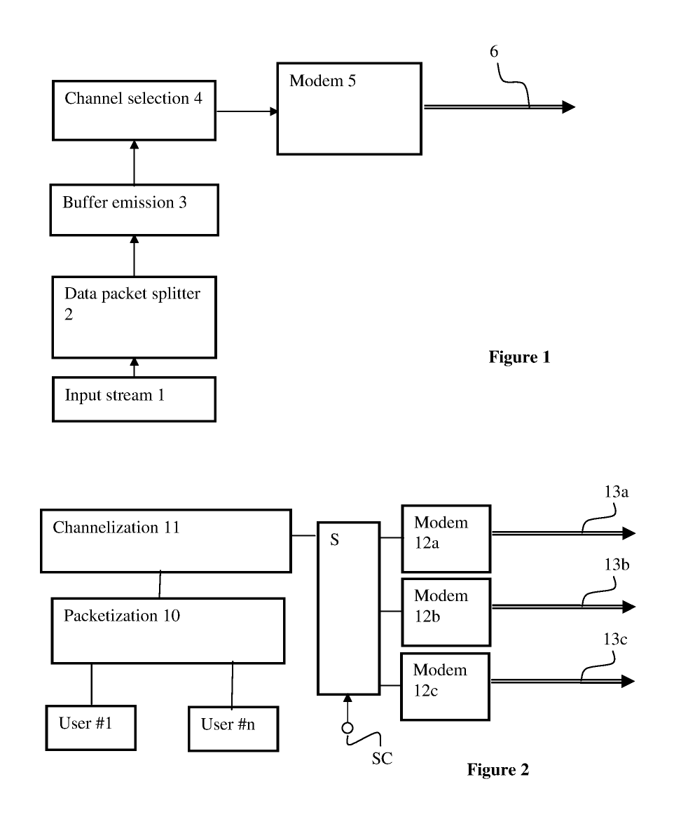

FIGS. 1 and 2 have been described previously.

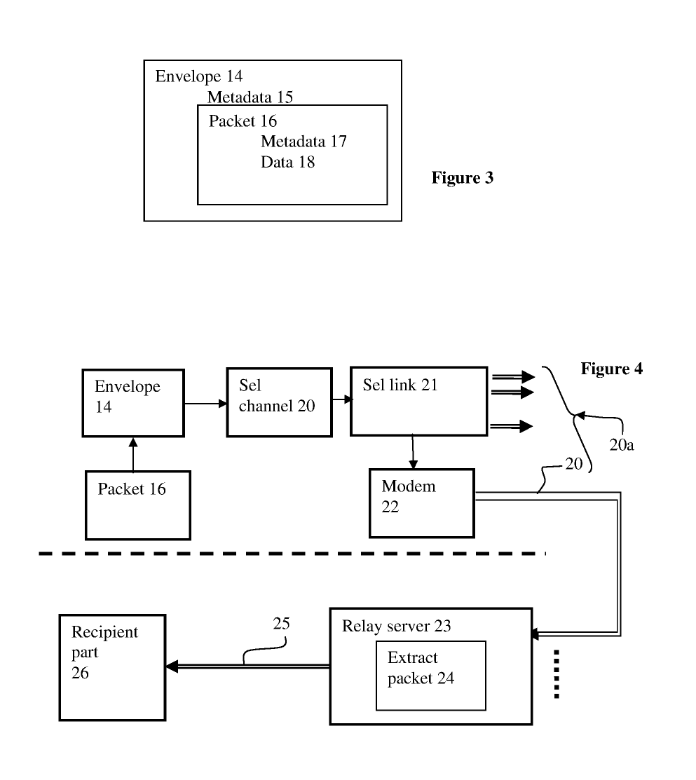

In FIG. 3 is represented a concept, used in the method of the invention, of encapsulating one or more data packets.

Each data packet 16 comprises two parts identified in a given protocol such as TCP or IP:
a collection of metadata 17 defined in the relevant protocol; and
a collection of communication data which in general correspond to a part of a communication message, for example an http request, or a group of data of a video stream, etc.

According to the same principle, but according to a protocol which may be original, at the prerogative of the person skilled in the art who applies the invention, the data packet 16 or the batch of data packets, is inserted into an “envelope” comprising its own metadata 15 and the data packet proper.

In particular, the original protocol used to form the envelope 14 makes it possible to determine the position of the bytes of the data packet or packets 16 “encapsulated” in the envelope 14 as well as the various metadata which are service data for the control method of the invention, as will be defined further on.

The data packets encapsulation technique is in particular used to take control of the forwarding of the data packets. On the other hand, the content of the encapsulated data packets, except perhaps of the public service data, is unknown to the controller that implements the control method of the invention. These service data must in particular allow the controller to retrieve each data packet sent or the response data packets in the communication system of the invention as will be apparent from what follows.

In FIG. 4 is represented an embodiment of a sender communication part in an implementation of the control method of the invention. The sender communication part represented in the upper part of FIG. 4 above the dashed line, communicates with a recipient communication part 26.

An electronic device delivers a data packet 16 to a device for encapsulating the data packet in an envelope 14 as has been set out in FIG. 3. The envelope 14 is then submitted to a channel selection device 20, and then to a link selection device 21. The identifiers of the selected channel and of the selected link are, in a particular embodiment, incorporated in the metadata 15 of the envelope 14.

The link selection device 21 has at its disposal a certain number of links 20a such as a geostationary satellite bidirectional data link, a non-geostationary satellite unidirectional data link, etc. The present invention is particularly useful when the communication part which executes the method of the invention comprises at least one nominal satellite link and when the communication part is implemented on a mobile object, a vehicle particularly. The other available links can also be satellite links, RF links of WiFi, WiMax, GSM or other type.

The selections of the channel and of the link are determined according to determined channel and link selection constraints or criteria recorded and implemented by a central controller (not represented) of the communication part of FIG. 4.

In another embodiment, the controller of the communication part of FIG. 4 which executes in particular the selection of the channel and/or of the link is a process external to the communication part such as a network master implemented remotely from the communication part. In this embodiment, not represented, the communication part controller communicates with the controlled communication part through its own communication linkup, or through one of the links 20a utilized by the sender communication part. In particular, in this embodiment, several communication parts can be controlled remotely by one and the same communication part controller.

When the envelope 16 is transmitted on a determined channel of a determined link 20, it is forwarded in a known manner on the link 20 up to a relay server 23.

In an exemplary embodiment, the link 20 of the communication part of FIG. 4 arrives directly at the communication input of the relay server 23. This entails a simplification.

In practice, in the case of a satellite link 20, the carrier RF beam bearing the communication sent by the sender communication part is relayed a first time by a satellite of a determined constellation and forwarded to a ground station. The ground station then decodes the communication signal so as to convert it into a communication signal suitable for a terrestrial communication, such as an optical fibre link, or cable link. It is this following link, not represented in FIG. 4, which is connected to the communication input of the relay-server 23. Other intermediate links are provided according to circumstances and the invention adapts easily to these heterogeneous links.

The relay-server 23 mainly comprises in the direction of communication of FIG. 4 a device for extracting the data packets 24 from the envelope transmitted by the sender communication part. The relay-server 23 then comprises a means for decoding the various metadata of the envelope and/or of the data packet contained and can then correctly route the data packet to the recipient communication part 26.

In this embodiment, the recipient communication part 26 might implement none of the provisions of the invention. The latter is transparent in respect of the operation thereof, this being a considerable advantage since the invention does not demand that an entire communications network be modified. This is ensured mainly by the mechanism of encapsulating the data packets in an envelope, by inserting this envelope on a channel of a determined link, and then by utilizing the relay-server. The mechanism for de-encapsulating the data packets when receiving the envelopes at the level of the sending communication part is symmetric with that for encapsulation on the return pathway or on the relay-server when receiving the envelope sent by the sender communication part. It will not be detailed further.

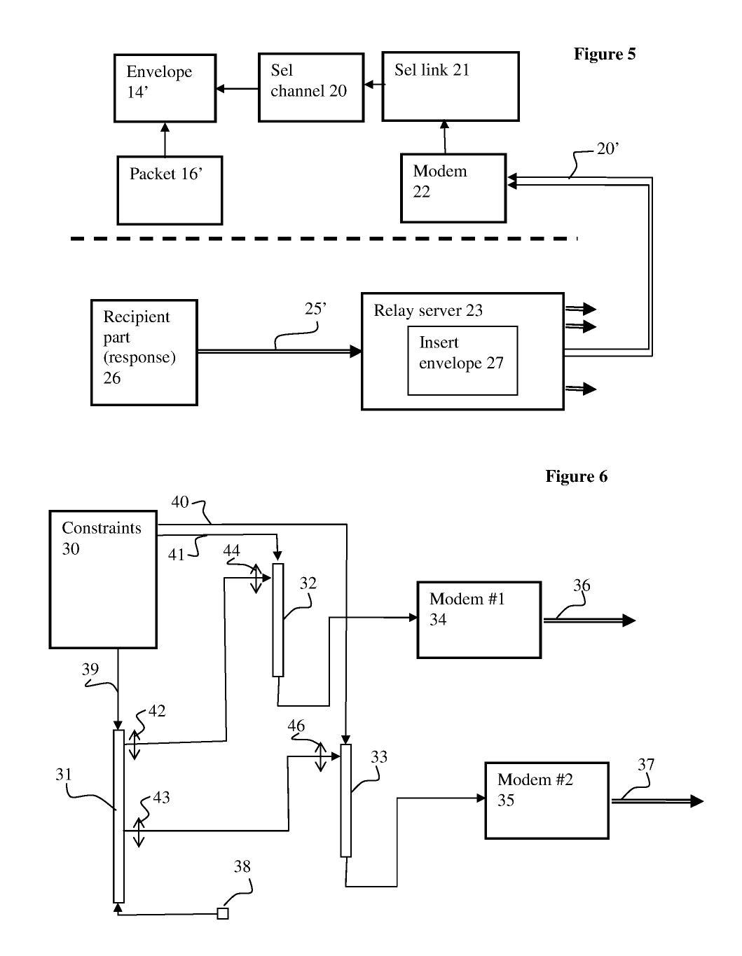

In another embodiment represented in FIG. 5, which can be combined with that aforementioned, the recipient communication part 26 of FIG. 4 enters response mode. This recipient communication part 26 can be an Internet server and the message that has been transmitted to it by the communication part 14-22 can be an http request produced by an internet client connected to the sender communication part of FIG. 4. In the http protocol, the server responds to the request for example via an html page. The latter, formulated at the level of the recipient communication part 26, must likewise be sliced up into communication data packets according to the known protocols. For this purpose, the data packets originating from the aforementioned sender communication part are transformed by the relay-server 23 so that the network address of the client, the author of the request (therefore of the message) inscribed in each data packet on the link 25 (FIG. 4), is no longer that of the sender communication part 14-22, but the network address of the relay server 23. It follows from this that the Internet server connected to the recipient communication part 26 returns the response html page to the relay-server 23 on the link 25′ which can be identical to the link 25 (FIG. 4) via which the data packets of the http request have travelled.

The relay-server 23 is equipped with a or cooperates with a resource which preserves the memory of the service data contained in the envelope 24 extracted during the request sending phase (FIG. 4). The storage of these service data will make it possible, in the response phase (FIG. 5), to return the response of the Internet server targeted by the sender communication part (FIG. 4). This resource 27 can then report the appropriate network addresses suitable for reaching the sender communication part 14-22 which becomes recipient of the response of the Internet server connected to the recipient communication part 26. Preferentially, the resource 27 of the relay-server 23 generates a new envelope so as to inscribe therein at least one packet of data arising from the response of the Internet server transmitted by the recipient communication part 26 in response mode. The operation is repeated for all the data packets of the response.

In one embodiment, the envelopes consisting of the resource 27, on the relay-server 23 are also transmitted in one or more channels of at least one link 20′ so as to be transmitted to the “sender” communication part 14-22. It is understood that if links other than the link 20, such as a link 20′ belonging to the set of links 20a managed by the communication part, and which must also belong to the set 20b of links managed by the relay-server 23, even indirectly, then a modem other than the specialized modem 22 on the link 20 will be activated on the “sender” communication part in response mode.

The envelopes of the response are then extracted from the link 20′ by its modem 22 and by the link selector 21. The envelopes arising from the various channels are thereafter logged. The envelope formatter 14′ thereafter aggregates the various envelopes corresponding to the complete response and transmits them to the packet formatter 16′ so that the data packets constituting the response produced by the recipient communication part 26 in response mode are extracted and routed to a user (not represented).

Subsequent to these operations the response of the Internet server connected to the “recipient” communication part 26 (FIGS. 4 and 5) is made available.

It is noted that the control method of the invention is appropriate also for processing data packets according to communication protocols other than the http protocol which has been described with the aid of FIGS. 4 and 5. In particular, the control method of the invention is suitable for communications according to most packet-based communication protocols.

Particularly, the relay-server being transparent in respect of the various communication parts, the method of the invention is compatible with most communication network control mechanisms, in particular for the control of the quality of the communications.

In the TCP protocol, the communication bitrates are verified by procedures which consist in generating data packets which are sent with an increasing speed until the recipient communication part can no longer accept any new packet. This mechanism is directly usable by implementing the control method of the invention.

Moreover, the operations which themselves use data packets are not modified by the control method of the invention, so that the invention adapts to the current situation of most communication protocols.

In FIG. 6 is represented another embodiment of the control method of the invention. The communication part of this embodiment comprises the devices already described in FIGS. 3 to 5. A particular resource 30 of the communication part controller is represented. The resource 30 executes a process in which predetermined constraints are estimated so as to determine the selection of channels and the selection of links when sending data packets in the form of envelopes such as defined in particular in FIG. 3.

The particular feature of the communication part controller of FIG. 6 resides in the fact that it is capable of controlling the transmission of several envelopes or data packets in parallel on several active links at the same time. This provision of the invention thus makes it possible to transfer certain data packets on one link and other data packets on another link. The constraints or criteria involved in selecting a channel or a link can take account of parameters:
of availability of the link and/or of the channel,
of the bitrate available on a link and/or a channel;
of the latency time and/or of the jitter on a link and/or a channel;
of the cost of forwarding on a link and/or a channel;
of the guarantee of availability of a link and/or of a channel
and of any other criterion making it possible to select one or other link from among the links available on the communications part.

This information can either derive from the analysis of the data of the dynamics of the streams or be extracted from the real-time local supervision information, or originate from the known static characteristics of the channels and of the links, contained in the configuration parameters of the router or communication part controller.

In FIG. 6, the communication part also comprises a storage buffer 31 for the data packets or envelopes each containing at least one data packet to be transmitted. The buffer comprises a control input 39 connected to the communication part controller 30 so as to direct a determined packet 42 or 43 respectively to another channel selection buffer 32 or 33. Each of these two buffers 32 and 33 also comprises a control input 41 and 40 connected to the communication part controller 30 so that a selected data packet or envelope 42 or 43 is respectively assigned to a determined channel 44 or 46 of the link 36 or respectively of the link 37. For this purpose, the reading output of each channel selection buffer 32 or 33 is connected to the input of a modem 34 for the link 36 or to the input of a modem 35 for the link 37.

It is understood that more than two links may be utilized by a communication part controller according to this embodiment of the invention. It is thus possible to deal with various predetermined constraints so as to orient all or part of the communication packets on one link or on another link.

It will thus be noted that in the foregoing, the method of the invention does not ignore the possibility of all the channels having a bidirectional characteristic, even on a unidirectional link. Indeed, most mechanisms for supervising the links possess a return resource based on acknowledgement of a packet, and therefore of an envelope according to the invention, on the channel, even in the case of a unidirectional link. The control method of the invention makes it possibly equally well to use the acknowledgement via the channel via which the communication of the packet—therefore of the envelope within the framework of the invention—has been executed as via another channel, with responsibility for the relay-server or another entity of the communication system to return an acknowledgement or other service data via an appropriate channel.

As has been described with the aid of FIGS. 4 and 5, the relay-server 23 is then equipped with resources complementary to those of the communication part represented in FIG. 6 so as to recombine the packets of data arising from the various links 36, 37 and to transmit them in the customary manner of the prior art to the recipient communication part.

Likewise, as has been described with the aid of FIGS. 4 and 5, the relay-server 23 is also equipped with resources complementary to those of the communication part represented in FIG. 6 so as to reform data packets arising in response from the recipient communication part to the sender communication part of FIG. 6.

In FIG. 6 is also represented an input 38 for communication data in the form of packets. The data input 38 is in general connected to a data-producing communication device. Among these devices may be mentioned a computer, a telephone of GSM or UMTS type, a graphical tablet or any automaton producing data and/or liable to receive same. Particularly, if several devices of this kind are provided on one and the same communication part, they can be united into at least one local network. Each user of the local network can thus be recorded at the level of the communication part controller 30 so as to generate determined channel and/or link selection constraints such as the right of access to certain links, a guaranteed minimum bitrate, a maximum communication cost and any other of the same kind. These constraints are then tested during a communication session so as to control the communications on the communication network with the aid of the control method of the invention.

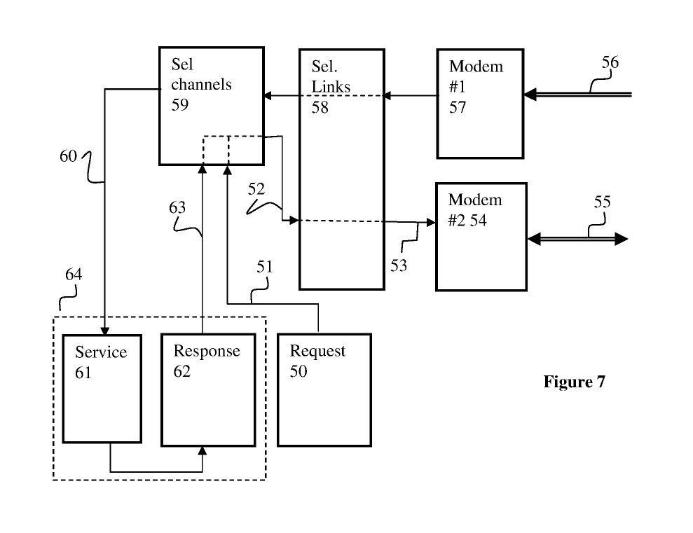

In FIG. 7 is represented a particular embodiment of the communication system implementing the control method illustrated in FIG. 6.

Indeed, there exist bidirectional links and unidirectional links. For example, satellite television broadcasting systems are mainly unidirectional. In certain applications, these satellite television links are capable of transmitting data packets to a recipient communication part at a high bitrate. However, circumstances exist where one needs a high communication bitrate in a single direction of transmission and a low communication bitrate in the other direction of transmission. This is often the case in a communication protocol such as http or ftp, but others too.

Taking up the case of the http protocol, the client sends a request comprising a small quantity of data and which do not often need a high bitrate. The communication part connected to such a client therefore needs a first low-bitrate link to a recipient communication part connected to an http server.

On the other hand, the http response of the Internet server interrogated by the client may demand high bitrates and a large volume of data for example if one or more multimedia documents are asked for in the request. In this case, a DBTV satellite television link is particularly suitable. The method, in particular that described with the aid of FIG. 6, of the invention is particularly suitable for heterogeneous communications of this type. However, it is noted that in the http protocol the Internet server needs a return pathway to receive the acknowledgements of transmission of the author client responsible for the http request. The embodiment of FIG. 7 affords such a return pathway.

The Internet client 50 is a user recorded on the communication part controller (not represented in FIG. 7). It begins by sending a request 51 in the form of data packets, formed into envelopes of the kind described hereinabove in FIGS. 3 to 6. These envelopes are then assigned to channels by the channel selector 59 and to a low-bitrate bidirectional link 55 under the control of the communication part controller executing the predetermined constraints associated with the client 50 and with the available links.

The request is then transmitted via the modem 54 and the link 55 to the relay-server described with the aid of FIGS. 4 and 5. The request is then submitted to the Internet server addressed in the request and therefore referenced in the data packets transmitted via envelopes to the relay-server 23 (not represented in FIG. 7) and then to the recipient communication part to which the Internet server is connected.

The Internet server then produces the response to the client in the form of data packets returned to the relay-server 23 which, detecting the identifiers of the data packets, encapsulates them in envelopes constructed so as to be forwarded through a high-bitrate unidirectional link 56. This link is a satellite television broadcasting link in an exemplary embodiment.

The modem 57 decodes the satellite television signal and the channels of this link are then extracted by the channel selector 59.

The communication packets 60 corresponding to the response of the Internet server are then routed to the user 50 by a packet extraction resource 61 which provides as output 63 the Internet server's data in response to the client 50.

When some of the data packets retransmitted as envelopes 60 are service data packets, the response to the remote server ought to be formulated by the requester client 50 and returned on the link 56 which, being unidirectional, does not allow the response.

For this purpose, there is provided a response resource 64 for responding to the service data packets 60 decoded by a packet extraction resource 61. When a service request is detected by the packet extraction resource 61, a response resource 62 generates the response envisaged in the communication protocol used and returns it in the form of data packets and envelopes 63 as has been described, through the channel selection resource 59, through the link selection resource 58 so as to load the low-bitrate link 55 through its modem 54, in the desired direction of transmission. The relay-server 23 (not represented in FIG. 7, but in FIGS. 4 and 5) then routes the relevant data packets to the addressed Internet server which receives them and interprets them as the natural response, according to the decided communication protocol, to the service request which prompted the return. Such is the case in particular when the Internet server tests the quality of the link which opens up for it by sending a succession of test data packets to verify the bitrate at which the link no longer responds (case of the IP protocol, MTU mechanism).

It is noted that, according to the invention, the data packets on account of their encapsulation in an envelope determined by the communication part controller, and on account of the fact that this same controller decides heterogeneous channels and links which are presented to it in the controlled communication system, are no longer compelled to follow solely the routing rules specific to the standard data packet-based communication protocols. On the contrary, the control method of the invention allows flexible control of the paths followed on the heterogeneous links by the various data packets.

It is thus noted that the use of the relay server according to the control method of the invention ensures the transparent nature in respect of the client-server pairs or any sender communication part to recipient communication part pair both of the rearrangement of the communication data packets or of the service data packets, and also of the choice of the channels and of the choice of the links operated under the control method of the invention.

In one embodiment, the control method of the invention executes a control of the communications by creating envelopes encapsulating one or more communication or service data packets of different characteristics. By utilizing the predetermined constraints in the communication part controller, provision is made to execute an algorithm for allotting the data packets as a function of the said predetermined constraints in envelopes for encapsulation of the said packets for example so that an envelope contains one or more packets of a determined characteristic such as for example the size of the packet. Other characteristics of data packets and/or of the envelopes can be freely devised to execute the algorithm for allotting the packets into envelopes. Mention will be made in particular of the addresses on the communication system, the lifetime of the packets, etc.

In one embodiment, the controller of the communication part executes a step of allotting the packets into envelopes on the basis of static information related to the supervision of the channels on the selected links. The allotment is executed by following the following steps:
a test checks whether the link is available;
if yes: a test checks whether the channel is available;
if yes: a plurality of static information comprising the bitrate of the link, the latency, the jitter, and the transmission cost is tested.

The bitrate of the link is for example expressed as a number of bytes per second or any other measure of this kind. The latency is expressed by the delay on reception of a data packet sent, the jitter is the variation of the date of reception of a packet with respect to a standard state, and the transmission cost expresses the availability of a communication unit on the link at a given instant. The transmission cost can be established directly in terms of economic cost of access to the link, for example in the case of a satellite link.

The allotment is then executed as a function of a degree of loading of the links used at the instant of communication and as a function of the latency. A degree of fill of each channel is then deduced therefrom. Allotment can then be random or based on detecting the degree of fill or based on the transmission cost per channel of the available channels, or based on a determined combination of these parameters.

In one embodiment, the controller of the communication part executes a step of allotting the packets into envelopes with a filtering based on a criterion using the characteristics of the channel and/or of the link, in particular in terms of transmission cost and/or latency or a combination of these characteristics. A string of envelopes containing one or more data packets are composed and their desired transmission characteristics are recorded. The controller then searches for the available channels/links and for each given class of characteristic of the channel/link pair, each envelope of the string of envelopes is allotted on the channel of the link of determined class which satisfies its desired transmission characteristics. Among the desired transmission characteristics, the controller for the filtering-based allotment uses the transmission cost or the latency for example to filter the envelopes whose desired transmission characteristic is marked urgent, towards the channels/links with the lowest latency.

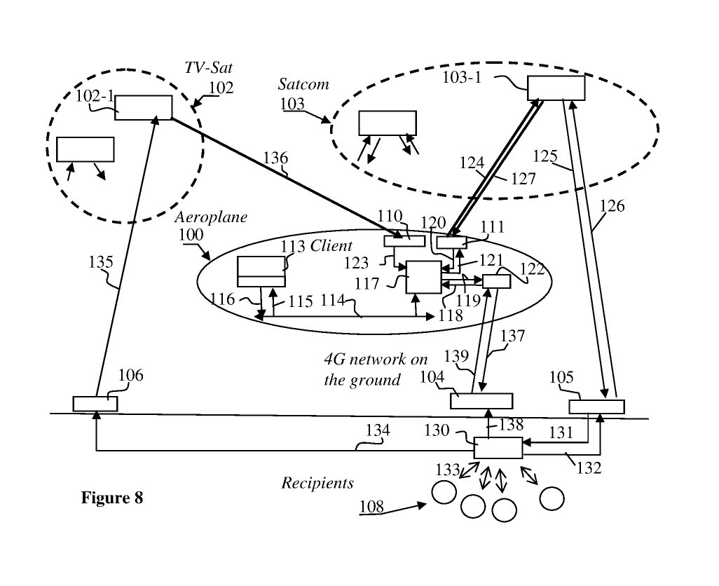

In FIG. 8 is represented an application to the field of aviation of the control method of the invention, in its embodiment of FIG. 7.

The “sender” communication part is embedded aboard an aeroplane 100 in which three links are provided by way of example:
a bidirectional low-bitrate link 122,129 to a constellation of communication satellites 103;
a unidirectional high-bitrate link 136 originating from a constellation of satellite television broadcasting satellites 102; and
a radiofrequency bidirectional link of 3G or 4G type 137, 139 with a cellular telephone base station on the ground 104.

In a conventional manner, the telephone link 137, 139 ceases when the aeroplane leaves the ground. Likewise, the link 136 ceases when the locked-on satellite such as the satellite 102-1 of a constellation of satellite television broadcasting satellites 102 no longer sees the aeroplane 100 in its coverage zone. Likewise, the link 137, 139 ceases when the locked-on satellite such as the satellite 103-1 of a constellation of satellite communications satellites 103 no longer sees the aeroplane 100 in its coverage zone.

As is known, the television broadcasting satellite 102-1 is connected by an up-path 135 to a ground station 106. The communications satellite 103-1 is connected by a bidirectional link 125, 126 with a ground station 105.

The aeroplane 100 is equipped according to the invention with a “sender” communication part which comprises a router 117 connected to modems or other systems for connection to a communication link. In the example of FIG. 8, this entails the modem 110 capable of receiving the beam of the television broadcasting satellite 102-1. The modem 110 is for this purpose connected to an antenna item of equipment making it possible to receive a satellite television beam from an aeroplane. Such a device is known from the prior art and will not be described here. Of course, this modem 110 is also connected to an item of equipment for broadcasting television transmissions and other broadcast services destined for specific items of television equipment installed aboard the aeroplane 100. These items of television equipment are not relevant to the invention and are not represented in FIG. 8.

The “sender” communication part in the aeroplane thereafter comprises a modem 120 capable of communicating on the bidirectional beam 124, 127 with a communication satellite 103-1. The modem 120 is for this purpose connected to an antenna item of equipment making it possible to send and to receive from an aeroplane data for communication with the communications satellite 103-1. Such a device is known from the prior art and will not be described here.

The “sender” communication part in the aeroplane thereafter comprises a modem 122 capable of communicating on the RF beam 137, 139 with a base station 104 of the ground cellular telephone network. The modem 122 is for this purpose connected to an antenna item of equipment making it possible to send and to receive from an aeroplane data for communication with the base station 104. Such a device is known from the prior art and will not be described here.

The router 117 is connected to its modems 110, 120 and 122 by links respectively 123, 120, 121 and 118, 119. In the embodiment of FIG. 8, the router 117 comprises the devices 58, 59 of FIG. 7 or else 16, 14, 20, 21 of FIGS. 4 to 6.

The communication data processed by the router 117 are produced or used by at least one user 113 connected as well as the router 117 on a local network 114 installed aboard the aeroplane. A local network such as this can bundle together computers, laptop computers, graphical tablets, mobile telephones or other devices of the same kind. These devices are used by human users such as the crew members or the passengers of the aeroplane. They can also comprise specialized automatons of the aeroplane which are intended to execute tasks in relation to the flight of the aeroplane.

The control method and the control system of the invention are used as has been described with the aid of FIGS. 3 to 7, aboard the aeroplane 100 so that it constitutes a sender communication part. The ground stations 104 for the communications of 3G or 4G RF type, 105 for the satellite communications and 106 for satellite television broadcasting are connected in a known manner to a relay-server 130 which executes the functions described in FIGS. 3 to 7 in particular:
of extraction of the data packets of the envelopes originating from the sender communication part;
of transmission to the recipient communications parts whose addresses are inscribed in the metadata of the data packets and/or of the envelopes;
of reception of the data packets originating from other communication parts, such as “recipient” communication parts for the “sender” communication part installed aboard the aeroplane 100, and also from other communication parts which may be “sender” for the communication part installed aboard the aeroplane which is then “recipient”; and
of encapsulation of the communication packets destined for the communication part installed aboard the aeroplane in envelopes which will be used by the router 117 of the communication part aboard the aeroplane 100.

For this purpose, the relay-server 130 is connected to various communication networks 133 on the ground, in the air, or in space, so as to communicate with other communication parts 108.

In one embodiment, the modems or the antenna items of equipment installed aboard the aeroplane 100 also comprise a device indicating or detecting a link cutoff. Such an occurrence can arise when the aeroplane 100 leaves the zone of coverage of a satellite 102-1 or 103-1. When the link cutoff indication or detection device is active, the communication part controller integrated into the router 117 which has been described previously with the aid of FIGS. 4 to 7, searches for an available link and then selects the channels specific to this still available link so as to assign them to the envelopes of the data packets which would otherwise be assigned to the link currently undergoing cutoff.

It follows from this that the impact of the link cutoff on the communication system of the invention can be reduced to the minimum. It is thus possible not to interrupt a communication session between a user 113 on the local network 114 with a server or other communication part 108.

A use in aeronautics has been described with the aid of FIG. 8. The control method and the communications system of the invention can be used in other fields and in particular:
in the maritime field aboard merchant or war vessels;
in the field of terrestrial transport aboard road vehicles or railway vehicles;
in the aerospace field aboard satellites or other space vehicles;
in the field of the connected objects, each connected object being able to constitute a communication part according to the method of the invention if at least one of the connected objects is fitted in particular with a communication part controller, with a device for aggregating the data packets into envelopes to be dispatched or for extracting the packets from the envelopes received, with a device for selecting the channels and links. A group of connected objects can then be connected by the said links to a relay-server and to communication parts as has been described above;
the vehicles indicated in the various aforementioned fields can be manned or unmanned, and then they comprise at least one automaton which can be connected as communication part in a communication system incorporating the invention and intended to control the operation thereof.

The control method and the communication system which implements it have been described within the framework of mobile applications. The principle of the control method as it has been defined finds application also on fixed communication parts. All types of links can be utilized. Even if the method of the invention solves the problem of the cutoff of the links as has been described within the framework of an application in mobility, the cutoff of the links is a problem which is not limited to mobile applications, but also impinges on fixed applications. Finally, as has been described, the principle of the control method of the invention is not limited to the solution of the problem of the cutoff of the beams, but affords a new solution for control of packet-based communications by allotting data packets to envelopes constructed on channels of several available links.

What is claimed is:

1. A method of control of a packet-based data communications system of the kind in which each data packet can be injected into a determined channel on a determined link, comprising:
at the level of a sender communication part, in encapsulating the data packet to be transmitted in an envelope, in selecting a determined channel and a determined link and in transmitting the envelope with the packet destined for a relay-server which executes an extraction of the data packet from its envelope and forwards it finally on a link to at least one destination communication part.

2. The method of claim 1 further comprising, at the level of the relay-server, modifying service metadata of each data packet in such a way that the destination communication part addresses its response in the form of data packets addressed to the relay-server.

3. The method of claim 2 further comprising, at the level of the relay-server, aggregating the data packets received from the recipient communication part in envelopes containing service metadata so as to transmit them to the sender communication part on a determined channel and/or a determined link the visual indicator and the another visual indicator comprise a similar color.

4. The method of claim 3 further comprising, transmitting the envelopes of data packets on distinct channels of distinct links.

5. The method of claim 4, wherein one of the links is unidirectional, and further comprising, constructing a return pathway of the unidirectional link by injecting the envelopes and/or the data packets on channels of a link available in the other direction of transmission.

6. The method of claim 1 further comprising, detecting a cutoff of a link so as to select the channels of another available link in such a way as not to interrupt the communication.

7. The method of claim 6, further comprising, selecting a link as a function of predetermined constraints, the predetermined constraints including: a bitrate available on a link; a latency time on a link; a cost of forwarding on a link.

8. The method of claim 1, further comprising, executing a predetermined algorithm for allotting the data packets to be encapsulated in envelopes determined as a function of constraints predetermined on the basis of characteristics of the data packets and/or of the envelopes, and in particular as a function of the size of the data packets.

9. The method of claim 8, wherein the allotment of the data packets is executed on the basis of static information related to the supervision of the channels, the static information including: a bitrate, a latency, a jitter, and a transmission cost.

10. The method of claim 8, wherein the allotment of the data packets is executed in a random manner or by taking account of the degree of fill of a channel on a given link and the transmission cost.

11. The method of claim 8, wherein the allotment of the data packets is executed by filtering the data packets according to desired transmission characteristics and by detecting these transmission characteristics on the channel/link pairs by filtering urgent packets on the low-latency channel/link pairs.

12. A communication system, comprising:
at least one communication part, the at least one communication part configured to exchange data packets on at least one link, where the at least one communication part includes:
a first device for aggregating at least one data packet in an envelope of data packets which also comprises service metadata, and
a second device for inserting the envelope into a channel selected from among a plurality of channels open on a link selected from among the available links, wherein the second device comprises at least one relay-server selected according to the service metadata of the envelope and which exchanges envelopes of data packets with the said at least one communication part, the relay-server comprising a device for extracting the data packets from the envelopes received from the said at least one communication part, and for transmitting them to at least one recipient communication part.

13. The communication system of claim 12, wherein the relay-server also includes a device for encapsulating the data packets transmitted by a communication part to the relay-server in an envelope so as to transmit them to the recipient communication part on a determined channel and/or a determined link.

14. The communication system of claim 13, wherein the at least one communication part comprises a communication part controller for executing the selection of a channel and of a link as a function of predetermined constraints.

15. The communication system of claim 14, wherein the communication part controller and the device for encapsulating the data packets in envelopes is implemented on a data packet router.

16. The communication system of claim 12, wherein the available links include a satellite link.

17. The communication system of claim 16, wherein the available links include a unidirectional link and a low-bitrate link to a communication satellite.

18. The communication system of claim 12, wherein the communication system is aboard an aeronautical, aerospace, maritime, terrestrial vehicle or on at least one connected object, the vehicle being able to be automatic.

19. The communication system of claim 12, wherein the communication system is installed on a fixed device.
